(19) United States
(12) Patent Application Publication
(10) Pub. No.: US 2015/0145725 A1
(43) Pub. Date: May 28, 2015

(54) NAVIGATION DEVICE AND CONTROL METHOD FOR REDUCING POWER CONSUMPTION THEREOF

(71) Applicant: Mitac International Corp., Gueishan Township (Taoyuan County) (TW)

(72) Inventor: Kuan-Hung Yeh, Taipei City (TW)

(21) Appl. No.: 14/549,857

(22) Filed: Nov. 21, 2014

(30) Foreign Application Priority Data
Nov. 26, 2013 (TW) 102142972

(51) Int. Cl. G01S 19/34; G01S 19/13; G01C 21/20

(52) U.S. Cl. CPC G01S 19/34; G01C 21/20; G01S 19/13
USPC 342/357.74; 342/357.51

(57) ABSTRACT

A navigation device includes an antenna to receive a satellite signal, a control unit to control provision of the satellite signal, an amplifier circuit for amplification of the satellite signal, and a positioning unit to position the navigation device based upon the satellite signal. When the navigation device has been successfully positioned, the control unit disables the amplifier circuit, and provides the satellite signal to the positioning unit for position calculation.

### CROSS-REFERENCE TO RELATED APPLICATION

This application claims priority to Taiwanese Application No. 102142972, filed on Nov. 26, 2013.

### BACKGROUND OF THE INVENTION

1. Field of the Invention

The invention relates to a navigation device, and more particularly to a navigation device that may reduce power consumption while maintaining good positioning quality. The invention also relates to a control method for reducing power consumption of the navigation device.

2. Description of the Related Art

Referring to FIG. 1, a conventional GPS (global positioning system) navigation device includes an amplifier circuit 93 electrically coupled between an antenna 91 and a positioning unit 92. The amplifier circuit 93 amplifies a satellite signal received by the antenna 91, so that the positioning unit 92 may effectively perform signal processing for positioning according to the amplified satellite signal. Although the amplifier circuit 93 assists in promotion of positioning quality, operation thereof contributes to considerable power consumption of the GPS navigation device.

### SUMMARY OF THE INVENTION

Therefore, an object of the present invention is to provide a navigation device that may reduce power consumption while maintaining good positioning quality.

According to one aspect of the present invention, a navigation device comprises:

an antenna disposed to receive a satellite signal;

a control unit electrically coupled to the antenna, and configured to control provision of the satellite signal received from the antenna;

an amplifier circuit electrically coupled to the control unit, and configured to amplify the satellite signal provided by the control unit; and

a positioning unit electrically coupled to the amplifier circuit and the control circuit, and configured to calculate a position of the navigation device according to the satellite signal provided by one of the amplifier circuit and the control unit.

The control unit is further configured to disable the amplifier circuit and to provide the satellite signal to the positioning unit when the positioning unit has successfully calculated the position of the navigation device.

Another object of the present invention is to provide a control method for reducing power consumption of the navigation device.

According to another aspect of the present invention, a control method is provided for reducing power consumption of a navigation device. The navigation device includes an antenna for receiving a satellite signal, a control unit electrically coupled to the antenna for receiving the satellite signal therefrom, an amplifier circuit electrically coupled to the control unit for receiving and amplifying the satellite signal provided by the control unit, and a positioning unit coupled to the amplifier circuit and the control unit. The control method comprises the step of:

determining, by the control unit, whether or not the positioning unit has successfully calculated a position of the navigation device.

When the determination made in the determining step is affirmative, the control method further comprises the steps of:

disabling, by the control unit, the amplifier circuit;

providing, by the control unit, the satellite signal received from the antenna to the positioning unit; and

calculating, by the positioning unit, the position of the navigation device according to the satellite signal provided by the control unit.

### BRIEF DESCRIPTION OF THE DRAWINGS

Other features and advantages of the present invention will become apparent in the following detailed description of an embodiment with reference to the accompanying drawings, of which:

FIG. 1 is a schematic diagram illustrating hardware connections in a conventional GPS navigation device;

FIG. 2 is a schematic diagram illustrating hardware connections in an embodiment of a navigation device according to the present disclosure; and

FIG. 3 is a flow chart illustrating steps of an embodiment of a control method for reducing power consumption of the navigation device according to the present disclosure.

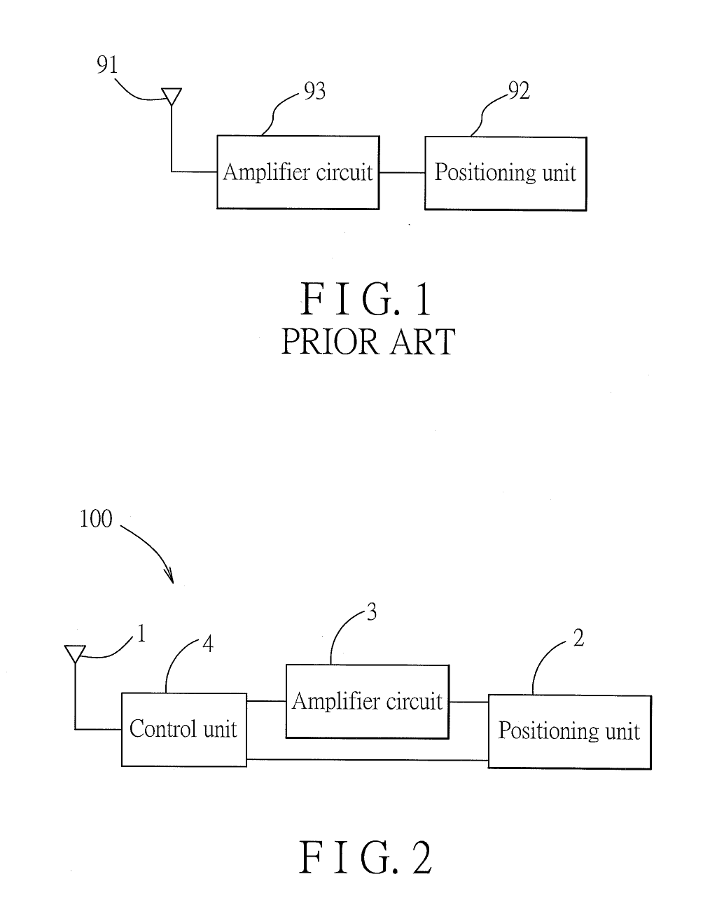

### DETAILED DESCRIPTION OF THE EMBODIMENT

Referring to FIG. 2, the embodiment of the navigation device 100 according to this disclosure is shown to include an antenna 1, a positioning unit 2, an amplifier circuit 3 electrically coupled to the positioning unit 2, and a control unit 4 electrically coupled to the antenna 1, the positioning unit 2 and the amplifier circuit 3.

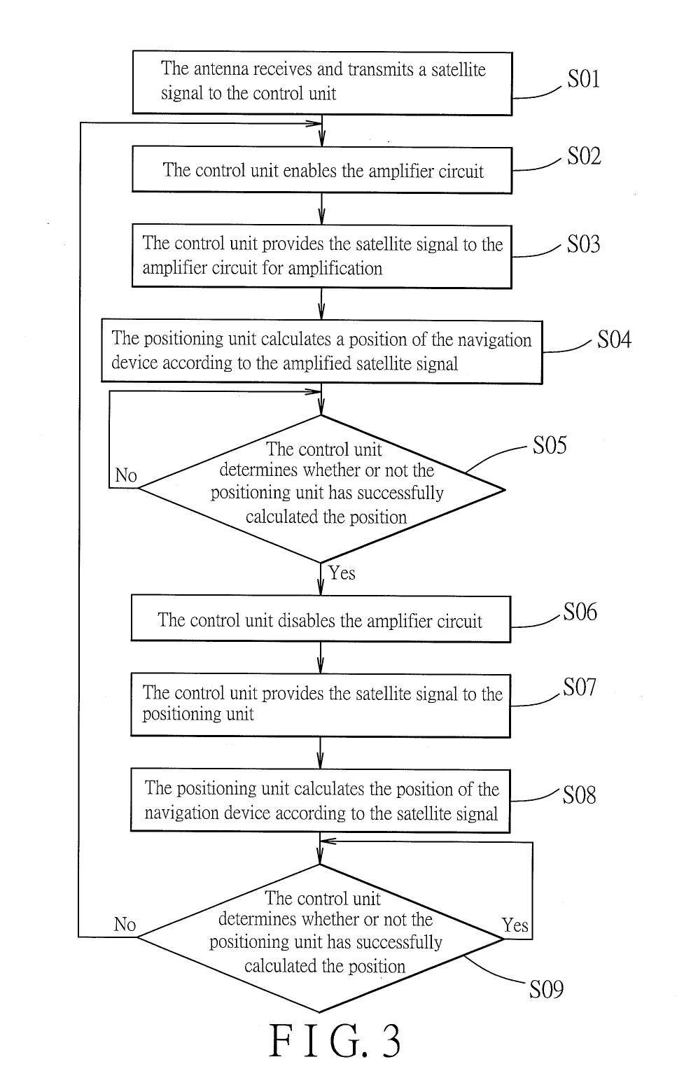

Further referring to FIG. 3, the control method for reducing power consumption of the navigation device 100 according to this disclosure is illustrated hereinafter. Note that, before performing the following steps, the navigation device 100 is in an initial state in which the navigation device 100 has yet to be positioned (i.e., the positioning unit 2 has not yet successfully calculated a position of the navigation device 100). In step S01, the antenna 1 receives and transmits a satellite signal to the control unit 4. Instep S02, the control unit 4 enables the amplifier circuit 3. In step S03, the control unit 4 provides the satellite signal to the amplifier circuit 3 for amplification by the amplifier circuit 3. Then, the amplifier circuit 3 provides the amplified satellite signal to the positioning unit 2. In step S04, the positioning unit 2 calculates current coordinates of the navigation device 100 according to the amplified satellite signal. Since the satellite signal has been amplified by the amplifier circuit 3, the positioning unit 2 may calculate the current coordinates more effectively. Instep S05, the control unit 4 determines whether or not the positioning unit 2 has successfully calculated the coordinates. The flow goes to step S06 when affirmative, and goes back to step S05 when negative. That is, when the navigation device 100 has not yet been positioned, the navigation device 100 may continuously proceed with signal processing that is associated with positioning operation until the positioning operation is successfully completed, and then proceed to step S06.

In step S06, the control unit 4 disables the amplifier circuit 3. In step S07, the control unit 4 provides the satellite signal to the positioning unit 2, i.e., the satellite signal is directly provided to the positioning unit 2 without amplification by the amplifier circuit 3. Note that step S06 is not necessarily performed before step S07. In other embodiments, steps S06 and S07 may be performed at the same time, or step S07 maybe performed before step S06, and the present invention should not be limited in this respect. In step S08, the positioning unit 2 calculates the current coordinates of the navigation device 1 according to the satellite signal provided by the control unit 4. The positioning unit 2 is capable of calculating the current coordinates using the non-amplified satellite signal because: when the navigation device 100 has already been positioned (i.e., a positioned state), since previous positioning data has been stored in the navigation device 100, the positioning unit 2 may cooperate with the previous positioning data to perform calculation for current positioning, so that a quality requirement of the satellite signal is relatively lower. For example, when the navigation device 100 has not yet been positioned (i.e., a non-positioned state), the navigation device 100 may require receipt of the satellite signals with a CNR (carrier to noise ratio, also abbreviated as C/N) higher than 30 from four satellites for successful positioning, while when in the positioned state, the navigation device 100 may only require receipt of the satellite signals with a CNR higher than 15 from four satellites for successful positioning. Therefore, the positioning unit 2 may still successfully calculate the current coordinates using the non-amplified satellite signals to perform positioning calculations under the positioned state.

Then, the flow goes to step S09, in which the control unit 4 determines whether or not the positioning unit 2 has successfully calculates the coordinates. The flow goes back to step S02 when negative, and goes back to step S09 when affirmative until the determination result is negative. That is, as long as the navigation device 100 is under the positioned state, the control unit 4 continuously determines whether or not the positioning unit 2 is able to successfully calculate the coordinates. Once the positioning unit 2 fails to calculate the coordinates and the navigation device 100 enters the non-positioned state, the control unit 4 enables the amplifier circuit 3, thereby enabling the positioning unit 2 to perform positioning calculation according to the amplified satellite signal.

In summary, the navigation device 100 and the control method of this disclosure employ the control unit 4 to enable the amplifier circuit 3 under the non-positioned state, so that the navigation device 100 may be quickly positioned according to the amplified satellite signal, and to disable the amplifier circuit under the positioned state in which a quality requirement of the satellite signal is relatively lower, thereby reducing power consumption of the navigation device 100. Accordingly, the navigation device 100 may achieve power saving while maintaining good positioning quality.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A navigation device comprising:
an antenna disposed to receive a satellite signal;
a control unit electrically coupled to said antenna, and configured to control provision of the satellite signal received from said antenna;
an amplifier circuit electrically coupled to said control unit, and configured to amplify the satellite signal provided by said control unit; and
a positioning unit electrically coupled to said amplifier circuit and said control circuit, and configured to calculate a position of said navigation device according to the satellite signal provided by one of said amplifier circuit and said control unit,
wherein said control unit is further configured to disable said amplifier circuit and to provide the satellite signal to said positioning unit when said positioning unit has successfully calculated the position of said navigation device.

2. The navigation device as claimed in claim 1, wherein, when said positioning unit has not successfully calculated the position of said navigation device, said control unit is further configured to enable said amplifier circuit and to provide the satellite signal to said amplifier circuit for amplification thereby, and said positioning unit is further configured to calculate the position of said navigation device according to the satellite signal provided and amplified by said amplifier circuit.

3. A control method for reducing power consumption of a navigation device that includes an antenna for receiving a satellite signal, a control unit electrically coupled to the antenna for receiving the satellite signal therefrom, an amplifier circuit electrically coupled to the control unit for receiving and amplifying the satellite signal provided by the control unit, and a positioning unit coupled to the amplifier circuit and the control unit, said control method comprising the step of:
determining, by the control unit, whether or not the positioning unit has successfully calculated a position of the navigation device; and
when the determination made in the determining step is affirmative, said control method further comprising the steps of:
disabling, by the control unit, the amplifier circuit;
providing, by the control unit, the satellite signal received from the antenna to the positioning unit; and
calculating, by the positioning unit, the position of the navigation device according to the satellite signal provided by the control unit.

4. The control method as claimed in claim 3, wherein, when the determination made in the determining step is negative, said control method further comprising the steps of:
providing, by the control unit, the satellite signal received from the antenna to the amplifier circuit;
amplifying, by the amplifier circuit, the satellite signal received from the control unit, and providing the satellite signal thus amplified to the positioning unit; and
calculating, by the positioning unit, the position of the navigation device according to the satellite signal provided and amplified by the amplifier circuit.
